(19) United States
(12) Patent Application Publication
(10) Pub. No.: US 2013/0341576 A1
(43) Pub. Date: Dec. 26, 2013

(54) TREE JACK AND ITS METHOD OF USE

(71) Applicant: Richard Lee Joy, Portola, CA (US)

(72) Inventor: Richard Lee Joy, Portola, CA (US)

(21) Appl. No.: 13/680,058

(22) Filed: Nov. 18, 2012

Related U.S. Application Data
(60) Provisional application No. 61/690,319, filed on Jun. 25, 2012.

(51) Int. Cl. A01G 7/06; A01G 23/00

(52) U.S. Cl. CPC A01G 7/06; A01G 23/00
USPC 254/100; 254/133 R

(57) ABSTRACT

One possible embodiment of the invention could be a tree jack comprising an extension member that connects to a telescopic mechanism; the telescopic mechanism being proximate to a base tube, the telescopic mechanism moves the extension member away from the base tube; the base tube has two tube ends, an open tube end and other tube end, the open tube end continuously connects to a hollow interior that accepts the extension member, the open tube end further supports the telescopic mechanism; a base platform that attaches to the base tube at the other tube end; wherein the extension member is placed into a tree having a list while the base platform supports the tree jack relative to a ground proximate to the tree, the telescopic mechanism forcibly extends the length of the tree jack to reduce the list of the tree.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention relates to devices used to move trees. More particularity to those devices used to correct a list of a tree.

### BACKGROUND

During a tree's lifetime, it may develop an off-center leaning or list due to a variety or combination of factors, including but not limited to such a limited root substructure, high winds, poor anchoring soil, and offset branch weight. This tree list may be seen as being desirable in some contexts such as natural or wild settings in that it adds to a character of the tree. In other contexts, such as man-controlled surroundings (e.g., residential and commercial landscaping; agricultural tree usage such as fruit orchards) such lists may be seen as being undesirable or even impairing the usefulness of the tree. A listing tree that is subject to subsequent high winds, microbursts, and the like may further end up being fully uprooted. Such a tree loss in an isolated wilderness landscape may be ignored while such a tree loss in a man-controlled environment may be considered a loss in both time and manpower to remove and replace with damaged/lost tree with a new specimen. Agricultural tree loss with subsequent replacement, if occurring at a significant rate, could have a sizable impact on a related agricultural business's fiscal operations.

In such situations where preventing tree loss due to list is desired, various corrective measures may be instituted to correct such list. If the tree is small or young enough, workers could may man-handle the tree to an upright position and then stake the tree (e.g., tying multiple ropes/cables around the truck/branches that are then subsequently anchored in the surrounding ground.) Staking a tree may be expensive in manpower costs; an impediment to orchard operations proximate to a tree; or in tight confines a hazard wherein the ropes and cables themselves could be tripping hazards. Further, unless carefully set and subsequently monitored, the anchoring ropes and cables as attached to the tree could cut into the tree and possibly damaging it or making susceptible to disease.

What could be needed is a tree list correcting apparatus that could be operated by a single person and project only from one side of the tree to otherwise reduce tripping hazards or other movement impediments to proximate to the tree.

### SUMMARY OF ONE EMBODIMENT OF THE INVENTION

Advantages of One or More Embodiments of the Present Invention

The various embodiments of the present invention may, but do not necessarily, achieve one or more of the following advantages:

to provide a tree list reducing device with a forced extension capability that can be placed and operated by single person;

the ability to jack a tree into a generally upright position and utilize the jacking means as tree stabilizing means;

to provide a tree jack with a screw-based telescopic capability that is easily and inexpensively constructed;

the ability to correct a tree list without the use of anchoring cords, wires, cables, and ropes;

to provide a tree jack that could stabilize a tree list while an operator assesses the practicality of adjusting the tree list with the tree jack; and

the ability to have one person both setup and operate a tree jack to stabilized a tree and then to correct its list.

These and other advantages may be realized by reference to the remaining portions of the specification, claims, and abstract.

### BRIEF DESCRIPTION OF ONE EMBODIMENT OF THE PRESENT INVENTION

One possible embodiment of the invention could be a tree jack comprising an extension member that connects to a telescopic mechanism; the telescopic mechanism being proximate to a base tube, the telescopic mechanism moves the extension member away from the base tube; the base tube having a hollow interior connecting two tube ends, an one open tube end and other tube end, the one open tube end supports the telescopic mechanism and accepts the extension member into the hollow interior; the base platform attaches to the base tube at the other tube end; wherein the extension member is placed into a tree having a list while the base platform supports the tree jack relative to the ground proximate to the tree, the telescopic mechanism forcibly extends the length of the tree jack to reduce the list of the tree.

One possible embodiment of the invention could be a process for using a tree jack to reduce the list of a tree comprising of the following steps, providing a tree jack with an extension member that is telescopically received within a base tube supported by a base platform with a telescopic mechanism that can forcibly move the extension member out of the base tube; securing an end of the extension member to a tree having a list; placing the base platform on ground proximate to the tree; activating the telescopic mechanism to increase an overall length of the tree jack; and moving the tree to reduce the amount of its list.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective cutaway view of one embodiment of the present invention.

FIG. 2 is substantially a perspective view of one possible embodiment of an extension member of the present invention.

FIG. 3 is substantially a perspective cutaway view of one possible embodiment of a telescopic mechanism of the present invention.

FIG. 4 is substantially a perspective cutaway view of one possible embodiment of the combination of base tube and base platform of the present invention.

FIG. 5 is substantially a perspective view of one possible embodiment of the base platform of the present invention.

FIG. 6 is substantially a perspective view of one possible embodiment of the present invention in the compact state.

FIG. 7 is substantially a flow chart schematic showing one possible embodiment of a process or a method of operating the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

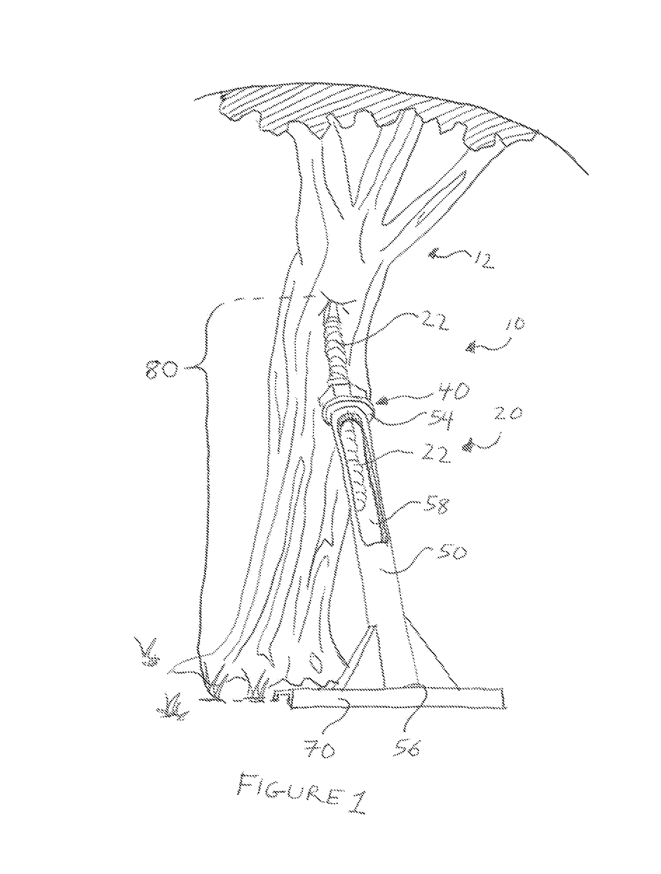

The present invention 10 could comprise of a tree jack 20 and its method of use 100. As substantially shown in FIG. 1, the tree jack 10 could comprise of an extension member 22, a telescopic mechanism 40, a base tube 50, and a base platform 70 wherein the extension member 22 passes through the telescopic mechanism 40 to be reversibly received through an open tube end 54 into a hollow interior 58 of the base tube 50. The telescopic mechanism 40 substantially and forcibly controls the extension member's movement (e.g., its extension and retraction) relative to the base tube 50 to substantially change the overall length 80 of the invention 10. The base platform 70 (as attached to other tube end 56 of the base tube 50) generally allows the invention 10 to be anchored onto and supported by the ground 14 proximate to the tree 12 being realigned. The telescopic mechanism 40 can be activated by an individual operator (NOT SHOWN) to forcibly extend (e.g., by increment) the extension member 22 from the base tube 50 to exert needed realignment force to a selected listing tree 12.

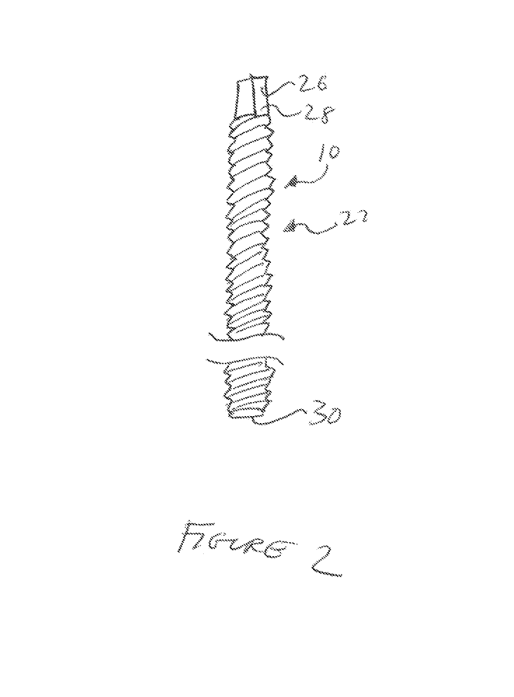

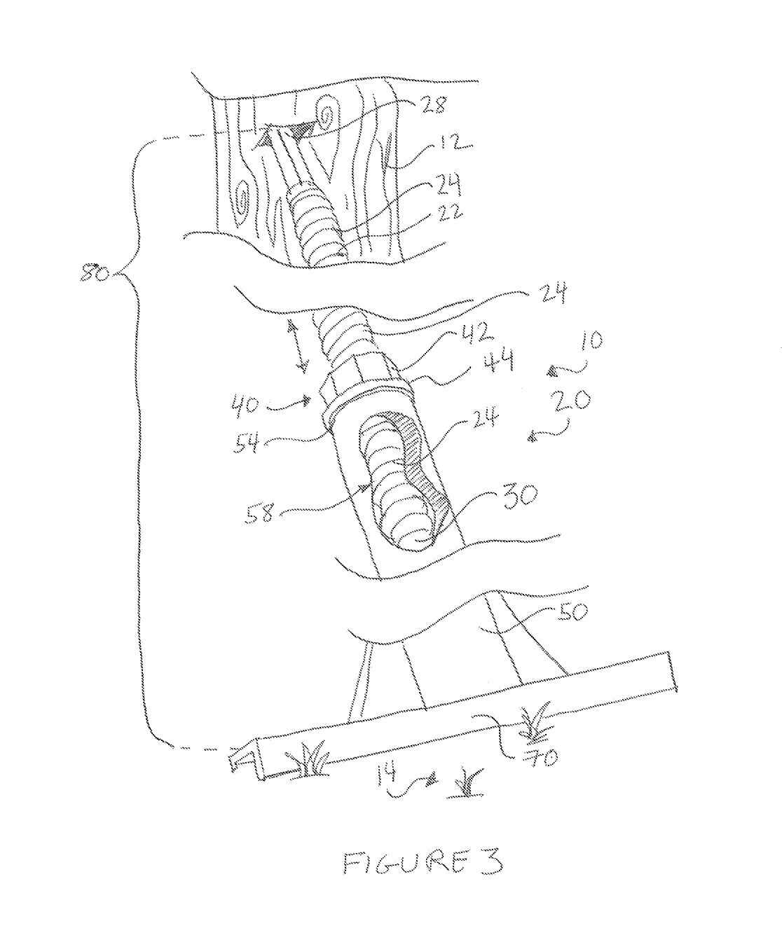

As substantially shown in FIG. 2, the extension member 22 could be in one possible embodiment a threaded rod 24 of definite length terminating in two rod ends. One rod end 26 could have a double-taper end 28 that could be set into the tree 12 (substantially shown in FIGS. 1 and 3) to substantially direct the invention's forced telescopic action into the tree and to prevent the threaded rod from rotating. The other rod end 30 could be received by the telescopic mechanism 40 (substantially shown in FIGS. 1 and 3) to be directed into a hollow interior 58 (substantially shown in FIGS. 1 and 3) of the base tube 50 (substantially shown in FIGS. 1 and 3).

As substantially shown in FIG. 3, the telescopic mechanism 40 in one possible embodiment could be an adjustment nut 42 with an accompanying washer 44. The thread of the adjustment nut 42 could match the thread of the threaded rod 24 allowing the adjustment nut 42 to be threaded upon the threaded rod 24 and subsequently move along the length of the threaded rod 24. The washer's diameter could be same or slightly larger than the diameter of the threaded rod 24 (to allow washer 44 to slip over the other rod end 30 and substantially place the washer 44 in between the adjustment nut 44 and other rod end 30.) The washer 44 could movably rest against the open tube end 54 and be held in that position by the adjustment nut 42 as the other rod end 30 passes through the open tube end 54 into the base tube's hollow interior 58. As the adjustment nut 42 is rotated about the threaded rod 24, the adjustment nut's rotation movement (relative to its respective one open tube end 54) is facilitated by its movement about the washer 44. The adjustment nut's rotation movement (e.g., provided by a wrench—not shown—attached to the adjustment nut 42 that is moved by the operator-not shown) controls the telescopic relationship between the rod 24 and the base tube 50 (e.g., the overall length 80 of the invention 10 and the amount of force being applied to the tree 12 to straighten it and/or hold it in the desired position.) The turning of the adjustment nut 42 (in one direction or the other) controls the amount of rod 42 that is received within the base tube 50. The portion of the weight of the tree 12/resistance provided by the tree's root structure (not shown) as being taken up by the double-taper end 28 onto to the rod 42 may be transmitted through the adjustment nut 42 and washer 44 onto the base tube 50/base platform 70 combination and onto the ground 14 proximate to the tree 12. The double-taper end 28, by securing the threaded rod 24 to the tree 12, prevents movement of the adjustment nut 42 from rotating the threaded rod 24 and instead allows that movement to extend/contract the overall length of the invention 10.

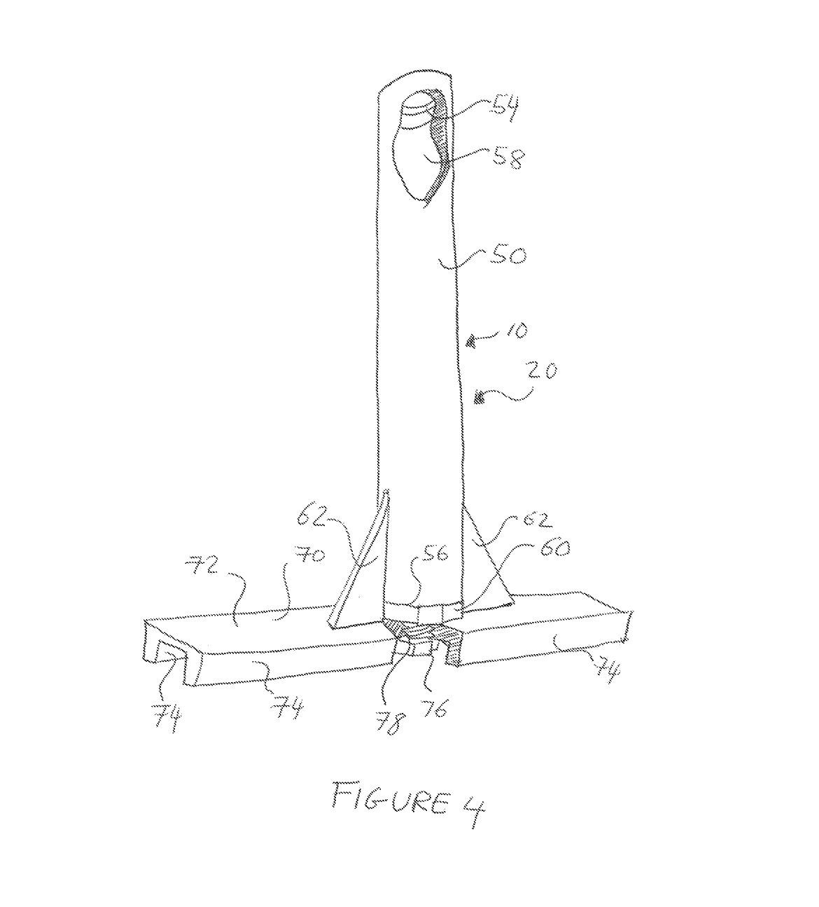

As substantially shown in FIG. 4, the base tube 50 could be a metal pipe 52 of definite length with an open tube end 54 continuously connecting to a hollow interior 58 and other tube end 56. The diameter of the pipe 52 generally matching or being greater than the diameter of the extension member 22 to allow the extension member 22 to be received through the open tube end 54 and into the hollow interior 58. The other tube end 56 could have a fastener nut 60 attached to it to receive a threaded portion of a fastener bolt 76 passing through the base platform 70 to attach the base platform 70 to the base tube 50. In another embodiment, the base tube 50 could be permanently welded to the base platform 70. For additional support, support gussets 62 (e.g., right-angled triangular shaped plates) could be affixed to opposing sides of the base tube 50 proximate the other tube end 56 to help the base tube 50 and base platform 70 substantially maintain a perpendicular relationship to one another.

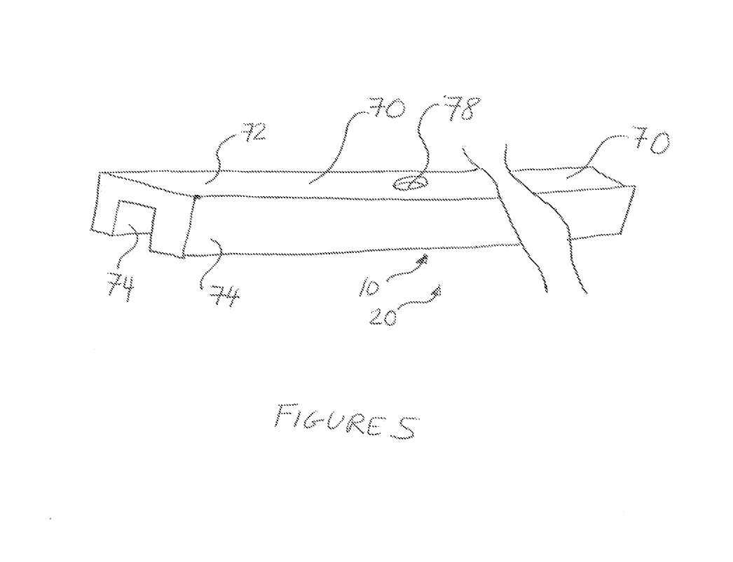

As substantially shown in FIG. 5, the base platform 70 could be channel bar with a top plate 72 that share common lengthwise edges with side plates 74 to form a U-shaped cross section. The middle of top plate 72 could feature an fastener aperture 78 through which the fastener bolt 76 on the underside of the base platform 70 could pass through to the top of the base platform 70 to engage the fastener nut 60 on the other pipe end 56 and reversibly attach the base pipe 50 to the base platform 70 (as substantially shown in FIG. 4.)

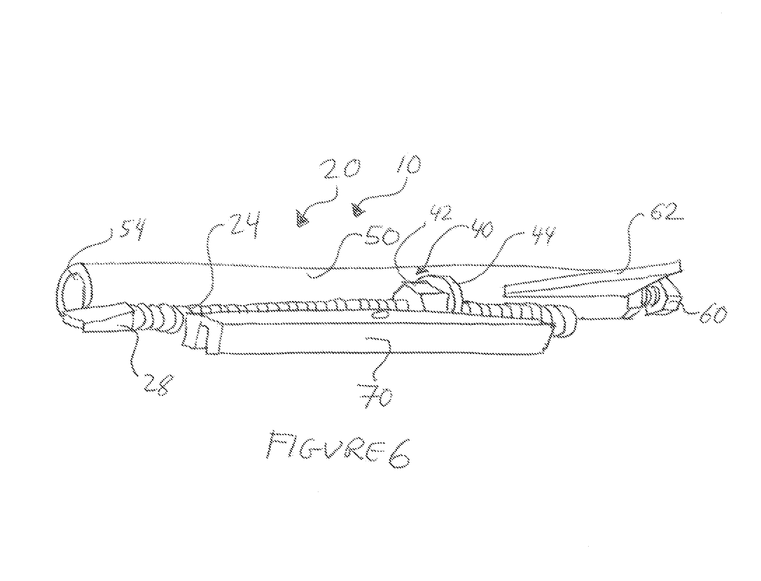

As substantially shown in FIG. 6, the invention 10 may broke down into its basic components and stacked/bundled together (e.g., extension member 22 with the telescopic mechanism 40 attached [e.g., adjustment nut 42 and washer 44 on the threaded rod 24]; base tube 50; and base platform 70) for carrying/storage purposes.

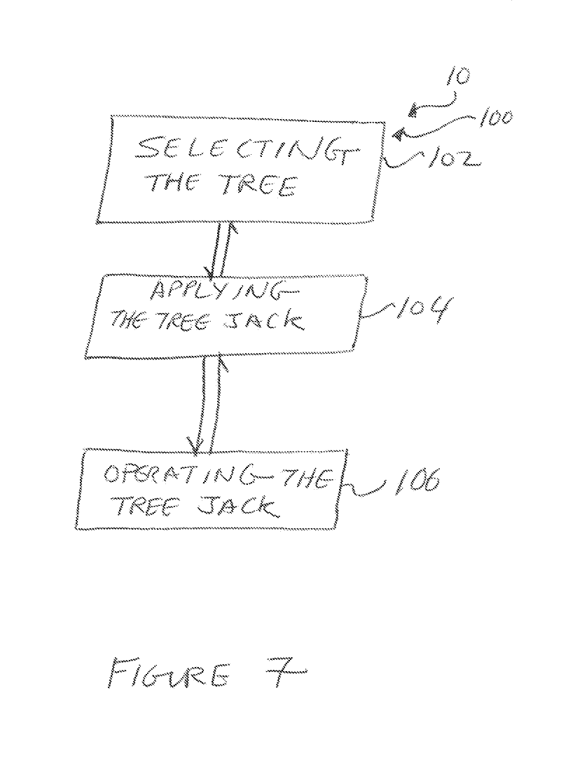

As substantially shown in FIG. 7, one possible embodiment for process or methodology for using the invention 10 could commence with step 102, selecting the tree. In this step 102, the operator could decide on which tree needs to be realigned in an upright position. Although the invention 10 can be seen as scalable to accommodate trees of various sizes, the invention, generally best results could be accomplished using the invention on a tree that has a trunk diameter of three to eight inches (e.g., up to sixty [60] feet tall.) The operator decides on which side of the tree is leaning and to which the direction the operator wants to move the tree, and how much movement in that direction is desirable for the tree. After this step is accomplished, the process could proceed to the step 104, applying the tree jack.

In step 104, the applying the tree jack, the operator could take the invention's components (in stored/carrying configuration) and could assemble them for operations. It should be noted that an individual or single operator could setup and operate the invention 10. The base platform could be bolted onto the other open tube end (with nut receiving the platform bolt.) The support gussets bottom edges could rest upon and generally be parallel to the top plate of the base platform. The extension member could have the nut and washer put on its other rod end with the nut run up along the length of the threaded rod to initially set the overall length of the invention so that invention can be properly located between the tree and surrounding ground.

The operator could then set the double-taper end into the truck of the tree. To accomplish this action, the operator could hammer the other rod end to drive double-taper end into the trunk about ¾ of an inch (e.g., for hardwood or fruit trees.) Alternatively, the operator could drive a ¾ inch deep hole into the truck. Either measure could help lock the double-taper end into the tree and prevent the extension member from rotating when the nut is moved along its length (e.g., to adjust the overall length of the invention.) The other rod end can then be inserted through the open tube end and be received within the hollow interior to complete the invention's assembly. The base platform could be located onto the surrounding ground so that the invention an angled or inclined orientation to the tree (e.g., so that the invention leans into the tree at about a forty-five [45°] degree angle.) At the substantial completion of this step, the process 100 could proceed to step 106, applying tree jack.

In step 106, operating the tree jack, the operator can use a wrench (e.g., a long-handled, fixed, a six-point, open-ended wrench) to rotate the fastener nut about the threaded rod so that it moves along the rod and towards the other rod end. The fastener nut's movement along the length of the non-rotating threaded rod generally causes an increase in the overall length of the invention. As the invention telescopes into the tree, the invention can be adjust or reduce (e.g., incrementally) the list of the tree. Generally, because the tree could be damaged if it is moved move than a few feet at a time (e.g., the list occurred as a growth issue rather than wind damage issue) the list correction or adjustment of the tree could take place over period of several years.

Once the list is adjusted to the operator's satisfaction, the operator could leave the tree jack in place as permanent support (especially if the branch weight of the tree is off-balance and conducive to recreating the list) for the tree. If the list is corrected and it does not appear that the list will be reintroduced by the tree's reset configuration, then the tree jack can be contracted, removed and dissembled into its compact state by reversing the steps of the above procedure 100. The tree jack could be transported to an operational site for list correction of another tree or it could be placed into storage.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

As disclosed in the application, the invention is a simple, easy-to-construct and easy-to-use, forcibly expanding, telescopic tree jack that can be used to adjust or reduce a list of a tree. The tree jack is easily assembled from simple components and can be disassembled into in a compact state for storing and carrying.

What is claimed is:

1. A tree jack comprising:
a) an extension member that connects to a telescopic mechanism, the extension member being a threaded rod, the threaded rod having a rod end that is double tapered to engage a tree to which the tree jack is applied to prevent a rotation of the extension member;
b) the telescopic mechanism being proximate to a base tube, the telescopic mechanism is an adjustable nut that is threaded upon the threaded rod to be able to move alone a length of the threaded rod to move the extension member relative to the base tube;
c) the base tube has two tube ends, an open tube end and other tube end, the open tube end continuously connects to a hollow interior that accepts the threaded rod, the open tube end further supports the telescopic mechanism;
d) a base platform that attaches to the base tube at the other tube end;
wherein the double tapered rod end is placed into a tree having a list while the base platform supports the tree jack relative to a ground proximate to the tree, the adjustable nut moves along the length of the threaded rod to forcible extend the length of the tree jack to reduce the list of the tree.

2. (canceled)

3. (canceled)

4. (canceled)

5. (canceled)

6. The tree jack of claim 1 wherein a washer is movably placed upon the threaded rod to be located between the adjustable nut and the open tube end.

7. The tree jack of claim 1 wherein the base tube and the base platform are held together in a perpendicular orientation to one another.

8. The tree jack of claim 7 wherein the base tube and the base platform are welded together.

9. The tree jack of claim 7 wherein a portion of a fastener passes through an aperture in the base platform to reversibly connect the base tube and the base platform.

10. The tree jack of claim 1 further comprises support gussets attached to the base tube proximate to the other tube end to further support a perpendicular orientation of the base tube and the base platform.

11. The tree jack of claim 10 wherein the support gussets are detached from the base platform to allow the tree jack to be disassembled into a compact storage state.

12. The tree jack of claim 1 wherein the tree jack has an incline relationship with the tree.

13. (canceled)

14. (canceled)

15. The process for using a tree jack of claim 14 further comprising the step of preventing the rotation of the threaded rod.

16. The process for using a tree jack of claim 21 wherein the step of activating the telescopic mechanism further comprises of rotating an adjustment nut around the.

17. The process for using a tree jack of claim 21 wherein the step of activating the telescopic mechanism further comprises of a step of moving the extension member out from a hollow interior of the base tube.

18. The process for using a tree jack of claim 21 wherein the step of placing the base platform further comprises a step of leaning the tree jack against the tree.

19. The process for using a tree jack of claim 21 further comprises a step of supporting the tree with the tree jack after desired removal of tree's list has been obtained.

20. The process for using a tree jack of claim 21 further comprises a step of compacting the tree jack after desired removal of tree's list has been obtained; removing the tree jack from the tree; and dissembling the tree jack into a compact state for storage or carrying.

21. A process for using a tree jack comprising of the following steps, but not necessarily in the order shown:
a) providing a tree jack comprising a threaded rod upon which an adjustment nut is threaded, the threaded rod further having a double tapered rod end, the threaded rod is telescopically received within a base tube as supported by a base platform;
b) securing the double tapered rod end into a tree having a list;
c) hammering the threaded rod to drive the double-taper rod end into the tree;
d) placing the base platform on ground proximate to the tree so that the jack has an incline relationship to the tree;
e) rotating the adjustment nut upon the threaded rod to increase an overall length of the tree jack; and
f) moving the tree with the tree jack to reduce the amount of the list of the tree.
